(19) United States
(12) Patent Application Publication
(10) Pub. No.: US 2021/0138789 A1
(43) Pub. Date: May 13, 2021

(54) LIQUID EJECTING APPARATUS AND MAINTENANCE METHOD OF LIQUID EJECTING APPARATUS

(71) Applicant: SEIKO EPSON CORPORATION, Tokyo (JP)

(72) Inventors: Kazushi ARAFUKA, Matsumoto-Shi (JP); Masanobu YAMAGUCHI, Matsumoto-Shi (JP)

(21) Appl. No.: 17/095,054

(22) Filed: Nov. 11, 2020

(30) Foreign Application Priority Data
Nov. 13, 2019 (JP) 2019-205807

(51) Int. Cl. B41J 2/165

(52) U.S. Cl. CPC B41J 2/16535; B41J 2/16526

(57) ABSTRACT

A liquid ejecting apparatus includes a liquid ejecting portion configured to eject a liquid from a nozzle disposed on a nozzle surface, a liquid receiving portion that receives the liquid discharged from the nozzle, a wiping mechanism that includes a wiping portion configured to wipe the nozzle surface, a liquid-ejecting-portion moving mechanism configured to move the liquid ejecting portion, and a control portion that performs an acceleration operation of moving the liquid ejecting portion after a discharge operation of discharging the liquid from the nozzle to the liquid receiving portion and before a wiping operation of wiping the nozzle surface by the wiping portion.

The present application is based on, and claims priority from JP Application Serial Number 2019-205807, filed Nov. 13, 2019, the disclosure of which is hereby incorporated by reference herein in its entirety.

### BACKGROUND

### 1. Technical Field

The present disclosure relates to a liquid ejecting apparatus such as a printer and a maintenance method of the liquid ejecting apparatus.

### 2. Related Art

For example, there is an ink jet printer as an example of a liquid ejecting apparatus that performs printing by ejecting an ink as an example of a liquid, from an ink jet head, as disclosed in JP-A-2009-178889. The ink jet printer includes a pressure setting portion that changes the setting of the pressure of the ink supplied to the ink jet head. When performing cleaning on the ink jet head, the pressure setting portion sets the pressure in a variable pressure chamber to be higher than the pressure when printing is performed in the ink jet printer, and then discharges the ink from the nozzle of the ink jet head.

When cleaning for discharging a liquid from the nozzle is performed, the liquid may stay on a nozzle surface in a state where the liquid adheres to the nozzle surface. When the amount of the liquid adhering to the nozzle surface is large, there is a concern that it is not possible to wipe the nozzle surface well.

### SUMMARY

To solve the above problem, a liquid ejecting apparatus includes a liquid ejecting portion configured to eject a liquid from a nozzle disposed on a nozzle surface, a liquid receiving portion that receives the liquid discharged from the nozzle, a wiping mechanism that includes a wiping portion configured to wipe the nozzle surface, a liquid-ejecting-portion moving mechanism configured to move the liquid ejecting portion, and a control portion that performs an acceleration operation of moving the liquid ejecting portion after a discharge operation of discharging the liquid from the nozzle to the liquid receiving portion and before a wiping operation of wiping the nozzle surface by the wiping portion.

To solve the above problem, there is provided a maintenance method of a liquid ejecting apparatus including a liquid ejecting portion configured to eject a liquid from a nozzle disposed on a nozzle surface, a liquid receiving portion that receives the liquid discharged from the nozzle, and a wiping mechanism that includes a wiping portion configured to wipe the nozzle surface. The method includes performing an acceleration operation of moving the liquid ejecting portion after a discharge operation of discharging the liquid from the nozzle to the liquid receiving portion and before a wiping operation of wiping the nozzle surface by the wiping portion.

### BRIEF DESCRIPTION OF THE DRAWINGS

FIG. 1 is a schematic diagram illustrating a liquid ejecting apparatus according to a first embodiment.

FIG. 2 is a schematic plan view illustrating a maintenance unit.

FIG. 3 is a schematic side view illustrating a wiping mechanism.

FIG. 4 is a schematic diagram illustrating a pressure adjusting mechanism and a supply mechanism in a state where an on-off valve is closed.

FIG. 5 is a schematic diagram illustrating a plurality of pressure adjusting mechanisms and pressure adjusting portions.

FIG. 6 is a flowchart illustrating contents of processing executed by a control portion in order to perform cleaning.

FIG. 7 is a schematic diagram illustrating the pressure adjusting mechanism and the supply mechanism in a state where the on-off valve is opened.

FIG. 8 is a schematic diagram illustrating the pressure adjusting mechanism and the supply mechanism during a wiping operation.

FIG. 9 is an exploded perspective view illustrating a pressure adjusting mechanism according to a second embodiment.

FIG. 10 is a perspective view illustrating the pressure adjusting mechanism.

FIG. 11 is a perspective view when FIG. 10 is viewed from another angle.

FIG. 12 is a side view of FIG. 11.

FIG. 13 is a side view when FIG. 12 is viewed from the opposite side.

FIG. 14 is a schematic diagram illustrating a pressure adjusting portion.

FIG. 15 is a cross-sectional view illustrating the pressure adjusting mechanism in a valve closed state.

FIG. 16 is a cross-sectional view illustrating the pressure adjusting mechanism in a valve opened state.

FIG. 17 is a schematic diagram illustrating a liquid ejecting apparatus according to a first modification example.

FIG. 18 is a schematic diagram illustrating a liquid ejecting apparatus according to a second modification example.

FIG. 19 is a schematic front view illustrating a wiping mechanism according to a third modification example.

### DESCRIPTION OF EXEMPLARY EMBODIMENTS

### First Embodiment

Hereinafter, a liquid ejecting apparatus and a maintenance method of the liquid ejecting apparatus according to a first embodiment will be described with reference to the drawings. The liquid ejecting apparatus according to the first embodiment is an ink jet printer that performs printing of characters and images by ejecting an ink as an example of a liquid, onto a medium such as paper.

In the drawings, assuming that a liquid ejecting apparatus 11 is placed on the horizontal plane, a direction of gravity is indicated by a Z-axis, and directions along the horizontal plane are indicated by an X-axis and a Y-axis. The X-axis, the Y-axis, and the Z-axis are orthogonal to each other. In the following description, a direction parallel to the Z-axis is also referred to as a vertical direction Z.

As illustrated in FIG. 1, the liquid ejecting apparatus 11 includes a liquid ejecting portion 12 that ejects liquid, and a supply mechanism 14 that supplies the liquid from a liquid supply source 13 to the liquid ejecting portion 12. The liquid ejecting apparatus 11 further includes a support stand 112 disposed at a position facing the liquid ejecting portion 12, a transporting portion 114 that transports a medium 113 in a transport direction Yf, and a liquid-ejecting-portion moving mechanism 115 that enables the liquid ejecting portion 12 to reciprocating in a scanning direction Xs and a direction opposite to the scanning direction Xs. The liquid ejecting portion 12 ejects a liquid from a plurality of nozzles 19 arranged on the nozzle surface 18. The liquid ejecting portion 12 performs printing by ejecting the liquid onto the medium 113 while being moved by the liquid-ejecting-portion moving mechanism 115.

In the first embodiment, the scanning direction Xs is parallel to the X-axis. The support stand 112 supports the medium 113 located at a printing position. The transport direction Yf is a direction along a transport path of the medium 113 and is a direction along a surface of the support stand 112, with which the medium 113 is in contact. In the first embodiment, the transport direction Yf is parallel to the Y-axis at the printing position.

The support stand 112 extends in the scanning direction Xs being also a width direction of the medium 113. The support stand 112, the transporting portion 114, and the liquid-ejecting-portion moving mechanism 115 are assembled in a main body 116 including a housing, a frame, and the like. A cover 117 is provided on the main body 116 to be openable and closable.

The transporting portion 114 includes a first transport roller pair 118 and a second transport roller pair 119 respectively disposed upstream and downstream of the support stand 112 in the transport direction Yf, and a guide plate 120 that guides the medium 113 disposed downstream of the second transport roller pair 119. When the first transport roller pair 118 and the second transport roller pair 119 are driven by a transport motor (not illustrated) to rotate while nipping the medium 113, the medium 113 is transported along the surface of the support stand 112 and the surface of the guide plate 120 while being supported by the support stand 112 and the guide plate 120.

The liquid-ejecting-portion moving mechanism 115 includes a guide shaft 122 extending in the scanning direction Xs, and a carriage 124 capable of reciprocating in the scanning direction Xs while being guided by the guide shaft 122. The carriage 124 moves by driving of a carriage motor (not illustrated). At least one liquid ejecting portion 12 is attached to the lower end portion of the carriage 124.

As illustrated in FIG. 2, the liquid ejecting apparatus 11 may include a first liquid ejecting portion 12A and a second liquid ejecting portion 12B arranged in the transport direction Yf. In the first embodiment, the first liquid ejecting portion 12A is located upstream of the second liquid ejecting portion 12B in the transport direction Yf and ejects a white ink from all nozzles 19. The white ink may be used for underlayer printing before color printing is performed when printing is performed on the medium 113 which is a transparent or translucent film, or the medium 113 of dark color. The underlayer printing may also be referred to as solid printing. In the first embodiment, the second liquid ejecting portion 12B ejects a plurality of types of color ink and a treatment liquid for promoting fixing of the ink.

The liquid ejecting apparatus 11 includes a maintenance unit 130 that performs maintenance of the liquid ejecting portion 12. The maintenance unit 130 is provided in a non-printing region which is a region where the liquid ejecting portion 12 does not oppose the medium 113 being transported in the scanning direction Xs. The maintenance unit 130 includes a first liquid receiving portion 131, a second liquid receiving portion 132, a wiping mechanism 133, a first suction mechanism 134, a second suction mechanism 135, a first capping mechanism 136, and a second capping mechanism 137. The maintenance unit 130 may include a waste liquid pan 138 provided vertically below a moving region in which the liquid ejecting portion 12 moves, and a waste liquid storage portion 139 that stores the waste liquid discharged from the liquid ejecting portion 12.

A position above the first capping mechanism 136 and the second capping mechanism 137 functions as a home position HP of the liquid ejecting portion 12. The home position HP is a start point when the liquid ejecting portion 12 moves. A region above the wiping mechanism 133 functions as a wiping region WA.

The configurations of the first liquid receiving portion 131 and the second liquid receiving portion 132 are the same as each other. The first liquid receiving portion 131 receives the liquid discharged from the nozzle 19 of the first liquid ejecting portion 12A. The second liquid receiving portion 132 receives the liquid discharged from the nozzle 19 of the second liquid ejecting portion 12B.

In the first embodiment, the position above the first liquid receiving portion 131 and the second liquid receiving portion 132 functions as a pressurized cleaning position CP of the first liquid ejecting portion 12A and the second liquid ejecting portion 12B. When the first liquid ejecting portion 12A and the second liquid ejecting portion 12B are located at the pressurized cleaning position CP, the nozzle surface 18 of the first liquid ejecting portion 12A faces the first liquid receiving portion 131, and the nozzle surface 18 of the second liquid ejecting portion 12B faces the second liquid receiving portion 132. The first liquid receiving portion 131 is larger than the nozzle surface 18 of the first liquid ejecting portion 12A in the scanning direction Xs and the transport direction Yf. The second liquid receiving portion 132 is larger than the nozzle surface 18 of the second liquid ejecting portion 12B in the scanning direction Xs and the transport direction Yf.

The liquid ejecting apparatus 11 positions the liquid ejecting portion 12 at the pressurized cleaning position CP and performs pressurized cleaning as an example of a discharge operation of discharging a liquid from the nozzle 19 by pressurizing the liquid in the liquid ejecting portion 12. That is, the first liquid receiving portion 131 and the second liquid receiving portion 132 may receive the liquid discharged by the pressurized cleaning.

The first liquid receiving portion 131 and the second liquid receiving portion 132 may receive the liquid ejected by flushing from the nozzle 19 of the liquid ejecting portion 12. Flushing is an operation of forcibly discharging the liquid from the nozzle 19 by driving an actuator 24 (described later) in the liquid ejecting portion 12 regardless of printing, for the purpose of preventing and eliminating clogging and the like of the nozzle 19.

The wiping mechanism 133 includes a band-like member 141 capable of absorbing a liquid. The wiping mechanism 133 includes a holding portion 142 that holds the band-like member 141, and a base portion 143 that holds the holding portion 142 to be movable in a first wiping direction W1 and a second wiping direction W2 which is opposite to the first wiping direction W1, and a pair of rails 144 extending along the Y-axis. The wiping mechanism 133 may include a wiping motor 145, a winding motor 146, and a power transmission mechanism 147 that transmits the power of the winding motor 146. The holding portion 142 has an opening 148 for exposing the band-like member 141. When the band-like member 141 has a width equal to or larger than the nozzle surface 18 in the scanning direction Xs, it is possible to efficiently maintain the liquid ejecting portion 12.

A through-hole 149 is provided in the base portion 143 at a position which is vertically above the waste liquid pan 138 and vertically below the moving region in which the second liquid ejecting portion 12B moves. The through-hole 149 is larger than the nozzle surface 18 of the second liquid ejecting portion 12B in the scanning direction Xs and the transport direction Yf. The waste liquid pan 138 receives the liquid which is dropped from the second liquid ejecting portion 12B and then passes through the through-hole 149.

The holding portion 142 reciprocates along the Y-axis on the rail 144 by the power of the wiping motor 145. Specifically, when the wiping motor 145 drives forward, the holding portion 142 moves in the first wiping direction W1 parallel to the Y-axis. When the wiping motor 145 drives backward, the holding portion 142 moves in the second wiping direction W2 opposite to the first wiping direction W1.

The wiping mechanism 133 may wipe the first liquid ejecting portion 12A and the second liquid ejecting portion 12B in at least one of steps including a step in which the holding portion 142 moves in the first wiping direction W1, and a step in which the holding portion 142 moves in the second wiping direction W2. Wiping corresponds to maintenance of wiping the nozzle surface 18 by the band-like member 141.

As illustrated in FIGS. 2 and 3, the wiping mechanism 133 includes an unwinding portion 152 having an unwinding shaft 151 and a winding portion 154 having a winding shaft 153. The unwinding portion 152 holds the band-like member 141 in a rolled state. The band-like member 141 unwound and unrolled from the unwinding portion 152 is transported to the winding portion 154 along the transport path. The wiping mechanism 133 may include an upstream roller 155, a tension roller 156, a pressing portion 157, a regulating roller 158, a first horizontal roller 159, and a second horizontal roller 160, which are provided in order from the upstream along the transport path of the band-like member 141. The holding portion 142 supports the unwinding shaft 151, the upstream roller 155, the tension roller 156, the pressing portion 157, the regulating roller 158, the first horizontal roller 159, the second horizontal roller 160, and the winding shaft 153 to be rotatable by using the X-axis as an axial direction.

The winding shaft 153 rotates by driving the winding motor 146. The winding portion 154 winds the band-like member 141 around the winding shaft 153 in a roll shape. The winding motor 146 may drive and rotate at least one of the unwinding shaft 151, the upstream roller 155, the tension roller 156, the pressing portion 157, the regulating roller 158, the first horizontal roller 159, and the second horizontal roller 160, along with the winding shaft 153.

In the first embodiment, the pressing portion 157 is a roller around which the band-like member 141 is wound. The pressing portion 157 pushes upward the band-like member 141 unwound from the unwinding portion 152, such that the band-like member 141 is projected from the opening 148. A portion of the band-like member 141, which is pressed by the pressing portion 157 functions as a wiping portion 161 capable of wiping the nozzle surface 18. That is, the wiping mechanism 133 includes the wiping portion 161, and the wiping portion 161 is held by the holding portion 142.

When the holding portion 142 moves in the first wiping direction W1 or the second wiping direction W2, the pressing portion 157 brings the band-like member 141 into contact with the nozzle surface 18 so as to enable wiping of the nozzle surface 18. The wiping mechanism 133 is capable of wiping the nozzle surface 18 of the liquid ejecting portion 12 located in the wiping region WA.

The wiping mechanism 133 has a pull-out portion 162 formed by pulling out the band-like member 141 to face the nozzle surface 18 in a non-contact manner. In the first embodiment, the pull-out portion 162 is a portion between the first horizontal roller 159 and the second horizontal roller 160. The pull-out portion 162 is larger than the nozzle surface 18 of the first liquid ejecting portion 12A in the scanning direction Xs and the transport direction Yf. The holding portion 142 illustrated in FIG. 2 is located at a receiving position. The receiving position is a position at which the first liquid receiving portion 131 and the pull-out portion 162 are arranged in the scanning direction Xs.

As illustrated in FIG. 2, the configurations of the first suction mechanism 134 and the second suction mechanism 135 are the same as each other. Each of the first suction mechanism 134 and the second suction mechanism 135 includes a suction cap 164, a suction holder 165, a suction motor 166 that causes the suction holder 165 to reciprocate along the Z-axis, and a pressure reducing mechanism 167 that reduces the pressure in the suction cap 164. The suction motor 166 moves the suction cap 164 between a contact position and a retracted position. The contact position is a position where the suction cap 164 comes into contact with the liquid ejecting portion 12 to surround the nozzle 19. The retracted position is a position where the suction cap 164 is separated from the liquid ejecting portion 12. The suction cap 164 may surround all the nozzles 19 collectively, or may surround some of the nozzles 19.

The liquid ejecting apparatus 11 may perform suction cleaning of positioning the liquid ejecting portion 12 above the first suction mechanism 134 and the second suction mechanism 135, surrounding one nozzle group by positioning the suction cap 164 at the contact position, and discharging the liquid from the nozzle 19 by reducing the pressure in the suction cap 164. That is, the first suction mechanism 134 and the second suction mechanism 135 may receive the liquid discharged by suction cleaning.

The configurations of the first capping mechanism 136 and the second capping mechanism 137 are the same as each other. Each of the first capping mechanism 136 and the second capping mechanism 137 includes a leaving cap 169, a leaving holder 170, and a leaving motor 171 that causes the leaving holder 170 to reciprocate along the Z-axis. The leaving holder 170 and the leaving cap 169 move upward or downward by driving the leaving motor 171. The leaving cap 169 moves from a separation position being a lower position, to a capping position being an upper position, and then comes into contact with the liquid ejecting portion 12 stopped at the home position HP.

The leaving cap 169 located at the capping position surrounds the opening of the nozzle 19. As described above, maintenance in which the leaving cap 169 surrounds the opening of the nozzle 19 is referred to as leaving capping. The leaving capping is a type of capping. The drying of the nozzle 19 is suppressed by the leaving capping. The leaving cap 169 may surround all the nozzles 19 collectively, or may surround some of the nozzles 19.

Next, the liquid ejecting portion 12 will be described in detail.

As illustrated in FIG. 4, the liquid ejecting portion 12 includes an ejection-portion filter 16 that captures air bubbles or foreign matters in the liquid, and a common liquid chamber 17 that stores the liquid that has passed through the ejection-portion filter 16. The liquid ejecting portion 12 further includes a plurality of pressure chambers 20 that cause the plurality of nozzles 19 formed on the nozzle surface 18 to communicate with the common liquid chamber 17. A portion of the wall surface of the pressure chamber 20 is formed by a vibration plate 21. The common liquid chamber 17 and the pressure chamber 20 communicate with each other through a first communication hole 22. The actuator 24 accommodated in an accommodation room 23 is provided at a position different from the common liquid chamber 17 on a surface on an opposite side of a portion of the vibration plate 21, which faces the pressure chamber 20.

In the first embodiment, the actuator 24 includes a piezoelectric element that contracts when a drive voltage is applied to the piezoelectric element. When the vibration plate 21 is deformed by contraction of the actuator 24 in response to the application of the drive voltage, and then the application of the drive voltage to the actuator 24 is released, in the liquid ejecting portion 12, the liquid in the pressure chamber 20 having a changed volume is ejected from the nozzle 19 in a form of a liquid droplet. That is, the liquid ejecting portion 12 drives the actuator 24 to eject the liquid from the nozzle 19.

The liquid supply source 13 is, for example, an accommodation container capable of accommodating the liquid. The liquid supply source 13 may be a cartridge that replenishes the liquid by exchanging the accommodation container or may be an accommodation tank which is capable of replenishing the liquid in a state of being mounted on a mounting portion 26 and includes a pouring port. When the liquid supply source 13 is a cartridge, the mounting portion 26 detachably holds the liquid supply source 13. At least one set of the liquid supply source 13 and the supply mechanism 14 is provided for each type of liquid ejected from the liquid ejecting portion 12.

The supply mechanism 14 includes a liquid supply flow path 27 enabling a supply of the liquid from the liquid supply source 13 on the upstream to the liquid ejecting portion 12 on the downstream in a liquid supply direction A. A portion of the liquid supply flow path 27 also functions as a circulation path in cooperation with a circulation path forming portion 28. That is, the circulation path forming portion 28 connects the common liquid chamber 17 and the liquid supply flow path 27 to each other. A circulation pump 29 that circulates the liquid in a circulation direction B in the circulation path is provided in the circulation path forming portion 28.

A pressurizing mechanism 31 is provided on the liquid supply source 13 side closer than the position where the circulation path forming portion 28 is connected in the liquid supply flow path 27. The pressurizing mechanism 31 pressurizes and supplies the liquid to the liquid ejecting portion 12 by causing the liquid to flow from the liquid supply source 13 in the supply direction A. A filter unit 32, a static mixer 33, a liquid storage portion 34, and a pressure adjusting device 47 are provided in a portion of the liquid supply flow path 27, which also functions as a circulation path on the downstream of the position where the circulation path forming portion 28 is connected, in order from the upstream.

The pressurizing mechanism 31 includes a positive displacement pump 38, a first one-way valve 39, and a second one-way valve 40. The positive displacement pump 38 is capable of pressurizing the predetermined amount of liquid by causing a flexible member 37 having flexibility to reciprocate. The first one-way valve 39 is provided upstream of the positive displacement pump 38 in the liquid supply flow path 27. The second one-way valve 40 is provided downstream of the positive displacement pump 38. The positive displacement pump 38 includes a pump chamber 41 and a negative pressure chamber 42 which are separated by a flexible member 37. The positive displacement pump 38 further includes a pressure reducing portion 43 that reduces the pressure in the negative pressure chamber 42, and a biasing member 44 that is provided in the negative pressure chamber 42 and biases the flexible member 37 toward the pump chamber 41.

The first one-way valve 39 and the second one-way valve 40 allow flowing of the liquid from the upstream to the downstream in the liquid supply flow path 27 and inhibit the flowing of the liquid from the downstream to the upstream. That is, the pressurizing mechanism 31 is capable of pressurizing the liquid supplied to the pressure adjusting device 47 in a manner that the biasing member 44 biases the liquid in the pump chamber 41 through the flexible member 37. Therefore, a pressurizing force at which the pressurizing mechanism 31 pressurizes the liquid is set by a biasing force of the biasing member 44. From such a point, in the first embodiment, the pressurizing mechanism 31 is capable of pressurizing the liquid in the liquid supply flow path 27.

The filter unit 32 is provided to be capable of capturing air bubbles or foreign matters in the liquid and performing exchange. The static mixer 33 causes changes such as direction change or division, in the flow of the liquid so as to reduce the bias of the concentration in the liquid. The liquid storage portion 34 stores the liquid in a volume-variable space biased by a spring 45, and reduces fluctuations in the pressure of the liquid.

Next, the pressure adjusting device 47 will be described in detail.

As illustrated in FIG. 4, the pressure adjusting device 47 includes a pressure adjusting mechanism 35 that is provided in the liquid supply flow path 27 and constitutes a portion of the liquid supply flow path 27, and a pressing mechanism 48 that presses the pressure adjusting mechanism 35. The pressure adjusting mechanism 35 includes a main body portion 52 in which a liquid inflow portion 50 into which the liquid to be supplied from the liquid supply source 13 through the liquid supply flow path 27 flows, and a liquid outflow portion 51 capable of accommodating the liquid are formed.

The liquid supply flow path 27 and the liquid inflow portion 50 are partitioned by a wall portion 53, and communicate with each other through a second communication hole 54 formed in the wall portion 53. The second communication hole 54 is covered with a filter member 55. Thus, the liquid in the liquid supply flow path 27 is filtered by the filter member 55 and then flows into the liquid inflow portion 50.

At least a portion of the wall portion of the liquid outflow portion 51 is configured by a diaphragm 56. The diaphragm 56 receives the pressure of the liquid in the liquid outflow portion 51 at a first surface 56a being the inner surface of the liquid outflow portion 51, and receives the atmospheric pressure at a second surface 56b being the outer surface of the liquid outflow portion 51. Therefore, the diaphragm 56 performs displacement in accordance with the pressure inside the liquid outflow portion 51. The volume of the liquid outflow portion 51 changes by the displacement of the diaphragm 56. The liquid inflow portion 50 and the liquid outflow portion 51 communicate with each other by a communication path 57.

The pressure adjusting mechanism 35 includes an on-off valve 59 capable of switching a state between a valve closed state and a valve opened state. The valve closed state illustrated in FIG. 4 is a state where the liquid inflow portion 50 and the liquid outflow portion 51 are not in communication with each other in the communication path 57. The valve opened state is a state where the liquid inflow portion 50 and the liquid outflow portion 51 are in communication with each other. The on-off valve 59 includes a valve portion 60 capable of blocking the communication path 57 and a pressure receiving portion 61 that receives pressure from the diaphragm 56. The on-off valve 59 moves when the pressure receiving portion 61 is pressed by the diaphragm 56. That is, the pressure receiving portion 61 also functions as a moving member that is movable in a state of being in contact with the diaphragm 56 that performs displacement in a direction in which the volume of the liquid outflow portion 51 is reduced.

An upstream biasing member 62 is provided in the liquid inflow portion 50, and a downstream biasing member 63 is provided in the liquid outflow portion 51. Both the upstream biasing member 62 and the downstream biasing member 63 biases the on-off valve 59 in a direction in which the on-off valve is closed. When pressure applied to the first surface 56a is lower than pressure applied to the second surface 56b, and a difference between the pressure applied to the first surface 56a and the pressure applied to the second surface 56b is equal to or greater than a predetermined value, the on-off valve 59 turns from the closed state into the opened state. The predetermined value is, for example, 1 kPa.

The predetermined value is a value determined in accordance with a biasing force of the upstream biasing member 62, a biasing force of the downstream biasing member 63, a force required for causing the diaphragm 56 to perform displacement, a seal load, pressure in the liquid inflow portion 50, which acts on the surface of the valve portion 60, and pressure in the liquid outflow portion 51. The seal load is a pressing force required for blocking the communication path 57 by the valve portion 60. That is, the predetermined value increases as the biasing forces of the upstream biasing member 62 and the downstream biasing member 63 increase.

The biasing forces of the upstream biasing member 62 and the downstream biasing member 63 are set such that the pressure in the liquid outflow portion 51 is in a negative pressure state in a range where a meniscus can be formed at a gas-liquid interface in the nozzle 19. When the pressure applied to the second surface 56b is atmospheric pressure, the pressure in the liquid outflow portion 51 is set to be −1 kPa, for example. In this case, the gas-liquid interface is a boundary at which the liquid and the gas are in contact with each other, and the meniscus is a curved liquid surface formed in a manner that the liquid comes into contact with the nozzle 19. Preferably, a recessed meniscus suitable for ejecting the liquid is formed in the nozzle 19.

In this manner, in the first embodiment, when the on-off valve 59 is closed in the pressure adjusting mechanism 35, the pressure of the liquid on the upstream of the pressure adjusting mechanism 35, specifically, the pressure of the liquid in the liquid inflow portion 50 and on the upstream of the liquid inflow portion 50 is normally set to positive pressure by the pressurizing mechanism 31. The pressure of the liquid on the downstream of the pressure adjusting mechanism 35, specifically, in the liquid outflow portion 51 and on the downstream of the liquid outflow portion 51 is normally set to negative pressure by the diaphragm 56. Thus, the pressure in the liquid ejecting portion 12 on the downstream of the liquid outflow portion 51 is normally set to negative pressure.

In the state illustrated in FIG. 4, when the liquid ejecting portion 12 ejects the liquid, the liquid accommodated in the liquid outflow portion 51 is supplied to the liquid ejecting portion 12 through the liquid supply flow path 27. Then, the pressure in the liquid outflow portion 51 decreases. When the difference between the pressure applied to the first surface 56a and the pressure applied to the second surface 56b of the diaphragm 56 becomes equal to or greater than the predetermined value, the diaphragm 56 deforms to be bent in the direction in which the volume of the liquid outflow portion 51 is reduced. When the pressure receiving portion 61 is pressed and moves by the deformation of the diaphragm 56, the on-off valve 59 is opened.

When the on-off valve 59 is opened, the liquid in the liquid inflow portion 50 is pressurized by the pressurizing mechanism 31. Thus, the liquid is supplied from the liquid inflow portion 50 to the liquid outflow portion 51, and the pressure in the liquid outflow portion 51 rises. Thus, the diaphragm 56 deforms to increase the volume of the liquid outflow portion 51. When the difference between the pressure applied to the first surface 56a of the diaphragm 56 and the pressure applied to the second surface 56b of the diaphragm 56 becomes smaller than the predetermined value, the on-off valve 59 turns from the opened state to the closed state and inhibits the flowing of the liquid.

In this manner, the pressure adjusting mechanism 35 adjusts the pressure in the liquid ejecting portion 12, which is the back pressure of the nozzle 19, by causing the diaphragm 56 to perform displacement and adjusting the pressure of the liquid to be supplied to the liquid ejecting portion 12.

As illustrated in FIG. 4, the pressing mechanism 48 includes an expansion and contraction portion 67, a pressing member 68, and a pressure adjusting portion 69. The expansion and contraction portion 67 forms a pressure adjustment chamber 66 on the second surface 56b side of the diaphragm 56. The pressing member 68 presses the expansion and contraction portion 67. The pressure adjusting portion 69 is capable of adjusting the pressure in the pressure adjustment chamber 66. The expansion and contraction portion 67 is formed of, for example, rubber or resin in a balloon shape, and expands or contracts by adjusting the pressure of the pressure adjustment chamber 66 by the pressure adjusting portion 69. The pressing member 68 has a bottomed cylindrical shape. A portion of the expansion and contraction portion 67 is inserted into an insertion hole 70 formed in the bottom of the pressing member 68.

The edge portion of an inner surface of the pressing member 68 on an opening portion 71 side is rounding-chamfered and rounded. The pressing member 68 forms an air chamber 72 that covers the second surface 56b of the diaphragm 56, by being attached to the pressure adjusting mechanism 35 such that the opening portion 71 is closed by the pressure adjusting mechanism 35. The pressure in the air chamber 72 is set to the atmospheric pressure, and the atmospheric pressure acts on the second surface 56b of the diaphragm 56.

That is, the pressure adjusting portion 69 expands the expansion and contraction portion 67 by adjusting the pressure in the pressure adjustment chamber 66 to pressure higher than the atmospheric pressure which is the pressure in the air chamber 72. Then, the pressing mechanism 48 presses the diaphragm 56 in the direction in which the volume of the liquid outflow portion 51 is reduced, in a manner that the pressure adjusting portion 69 expands the expansion and contraction portion 67. At this time, the expansion and contraction portion 67 of the pressing mechanism 48 presses a region of the diaphragm 56, which is in contact with the pressure receiving portion 61. The area of the region of the diaphragm 56, which is in contact with the pressure receiving portion 61 is larger than the cross-sectional area of the communication path 57.

As illustrated in FIG. 5, the pressure adjusting portion 69 includes a pressurizing pump 74 that pressurizes a fluid such as air and water, a connection path 75 that connects the pressurizing pump 74 and the expansion and contraction portion 67, a detection portion 76, and a fluid pressure adjusting portion 77. The detection portion 76 and a fluid pressure adjusting portion 77 are provided in the connection path 75. The downstream of the connection path 75 may be branched into a plurality of parts, and the plurality of parts may be connected to the expansion and contraction portions 67 of a plurality of pressure adjusting devices 47. When a switch valve of switching the state of a flow path between a communication state and a non-communication state is provided in each of a plurality of branched flow paths of the connection path 75, it is possible to selectively supply the pressurized fluid to the plurality of expansion and contraction portions 67.

That is, the fluid pressurized by the pressurizing pump 74 is supplied to each of the expansion and contraction portions 67 through the connection path 75. The detection portion 76 detects the pressure of the fluid in the connection path 75, and the fluid pressure adjusting portion 77 is configured by, for example, a safety valve. When the pressure of the fluid in the connection path 75 becomes higher than predetermined pressure, the fluid pressure adjusting portion 77 automatically opens the valve to discharge the fluid in the connection path 75 to the outside, and thus decreases the pressure of the fluid in the connection path 75.

As illustrated in FIG. 5, the liquid ejecting apparatus 11 includes a control portion 180 that controls driving of various components of the liquid ejecting apparatus 11. The control portion 180 is a microcomputer including a CPU, ROM, RAM and the like. The control portion 180 controls various operations performed by the liquid ejecting apparatus 11, in accordance with a program stored in the ROM.

The control portion 180 performs a printing operation of forming a character or an image on a medium 113 by alternately performing a transport operation of driving the transporting portion 114 to transport the medium 113 by a unit transport amount and an ejection operation of ejecting a liquid from the liquid ejecting portion 12 onto the medium 113 while moving the carriage 124 in the scanning direction Xs.

The control portion 180 drives the pressurizing pump 74 in the pressing mechanism 48 to supply the pressurized fluid to the expansion and contraction portion 67. As a result of the expansion and contraction portion 67 expanding in this manner, the diaphragm 56 performs displacement in the direction of reducing the volume of the liquid outflow portion 51, and the on-off valve 59 is opened. As described above, the control portion 180 performs a control of opening and closing the on-off valve 59, based on the driving of the pressing mechanism 48.

The control portion 180 performs a discharge operation of making the pressure of the liquid in the liquid ejecting portion 12 larger than the pressure outside the liquid ejecting portion 12, for example, the atmospheric pressure, and thus discharging the liquid pressurized by the pressurizing mechanism 31 from the nozzle 19 to the first liquid receiving portion 131 and the second liquid receiving portion 132. This operation is also referred to as pressurized cleaning. When performing the discharge operation, the control portion 180 causes the pressing mechanism 48 to press the diaphragm 56 so as to open the on-off valve 59, and supplies the liquid pressurized by the pressurizing mechanism 31 to the pressure adjusting mechanism 35 and the liquid ejecting portion 12.

When the discharge operation is performed for a long period of time, the consumption amount of the liquid discharged from the nozzle 19 of the liquid ejecting portion 12 is greater than the amount of the liquid supplied by the pressurizing mechanism 31 to the liquid ejecting portion 12. Thus, the flow velocity of the liquid flowing through the liquid supply flow path 27 may gradually decrease. In this case, there is a concern that it is not possible to efficiently discharge foreign matters such as air bubbles existing in the liquid ejecting portion 12 and the liquid supply flow path 27.

Thus, in the first embodiment, the control portion 180 repeats the discharge operation and a discharge stop operation of stopping the discharge operation, in a short cycle. Thus, an occurrence of a situation in which the flow velocity of the liquid flowing through the liquid supply flow path 27 gradually decreases is suppressed, and an occurrence of a situation in which an action of discharging foreign matters such as air bubbles existing in the liquid supply flow path 27 is weakened is suppressed.

Next, a flow of processing executed by the control portion 180 in the first embodiment when performing cleaning including the discharge operation will be described with reference to the flowchart illustrated in FIG. 6. The series of processes may be executed every preset control cycle, may be executed only when it is predicted that liquid ejection failure has occurred in the nozzle 19, or may be executed manually by a user or an operator of the liquid ejecting apparatus 11.

As illustrated in FIG. 6, the control portion 180 resets a counter Cnt being a variable for counting, to “0 (zero)” (Step S11) and performs the discharge operation (Step S12). Specifically, the control portion 180 controls the driving of the pressing mechanism 48 and causes the diaphragm 56 to perform displacement in the direction in which the volume of the liquid outflow portion 51 decreases, thereby opening the on-off valve 59. In this manner, the pressurized liquid flows into the liquid outflow portion 51, the liquid supply flow path 27, the common liquid chamber 17, the pressure chamber 20, and the nozzle 19, and thus the liquid is discharged from the nozzle 19.

Then, the control portion 180 performs a discharge stop operation of stopping the discharge operation (Step S13). Specifically, the control portion 180 controls the driving of the pressing mechanism 48 and causes the diaphragm 56 to perform displacement in the direction in which the volume of the liquid outflow portion 51 increases, thereby closing the on-off valve 59. In this manner, the pressurized liquid is not supplied to the downstream of the pressure adjusting mechanism 35. A period from the end of the discharge operation to the start of the discharge stop operation may be, for example, about 0.1 seconds to 1 second.

Then, the control portion 180 increments the counter Cnt by “1” (Step S14), and determines whether or not the value of the counter Cnt is equal to or greater than a determination count CntTh (Step S15). Here, the determination count CntTh is a determination value for determining how many times the discharge operation and the discharge stop operation are repeated. Therefore, the determination count CntTh may be determined based on the specifications of the liquid ejecting apparatus 11 or setting of the user. When whether or not the liquid ejection failure has occurred in all the nozzles 19 of the liquid ejecting portion 12 is detected, the determination count CntTh may be determined in accordance with the number of defective nozzles in which the liquid ejection failure has occurred.

When the value of the counter Cnt is smaller than the determination count CntTh (Step S15: NO), the control portion 180 causes the process to transition to the previous Step S12. When the value of the counter Cnt is equal to or greater than the determination count CntTh (Step S15: YES), the control portion 180 performs an acceleration operation (Step S16). Then, the control portion 180 performs a stop operation (Step S17) to stop the liquid ejecting portion 12 moving with the acceleration operation, in the wiping region WA.

The control portion 180 controls the wiping mechanism 133 to perform the wiping operation of wiping the nozzle surface 18 (Step S18). With the wiping operation, the liquid and the foreign matters adhering to the nozzle surface 18 are removed, and a meniscus suitable for ejecting the liquid is formed in the nozzle 19. Then, the control portion 180 temporarily ends the series of processes. In this manner, the maintenance in the first embodiment is an operation including the discharge operation, the acceleration operation, the stop operation, and the wiping operation, and is an operation for recovering the liquid ejecting performance of the liquid ejecting portion 12.

The action in the first embodiment will be described.

When the liquid ejecting apparatus 11 performs the printing operation, some nozzles 19 of the plurality of nozzles 19 provided in the liquid ejecting portion 12 may become defective nozzles in which liquid ejection failure has occurred. In this case, cleaning is performed to recover the liquid ejection failure of the defective nozzle.

As illustrated in FIG. 7, when cleaning is performed, the pressurizing pump 74 is driven, and the pressurized fluid is supplied to the expansion and contraction portion 67. Then, the expansion and contraction portion 67 to which the fluid is supplied expands and presses the region of the diaphragm 56, which is in contact with the pressure receiving portion 61, thereby opening the on-off valve 59.

That is, the pressing mechanism 48 moves the pressure receiving portion 61 against the biasing forces of the upstream biasing member 62 and the downstream biasing member 63, thereby opening the on-off valve 59. In this case, since the pressure adjusting portions 69 are connected to the expansion and contraction portions 67 of the plurality of pressure adjusting devices 47, the on-off valves 59 of all the pressure adjusting devices 47 are opened.

At this time, the diaphragm 56 is deformed in the direction in which the volume of the liquid outflow portion 51 is reduced. Thus, the liquid accommodated in the liquid outflow portion 51 is pressed out toward the liquid ejecting portion 12. That is, the pressure at which the diaphragm 56 presses on the liquid outflow portion 51 is transmitted to the liquid ejecting portion 12, and thus, the meniscus is broken and the liquid overflows from the nozzle 19. That is, the pressing mechanism 48 presses the diaphragm 56 such that the pressure in the liquid outflow portion 51 becomes higher than the pressure at which at least one meniscus is broken. For example, the pressure at which the meniscus is broken is pressure at which the liquid-side pressure at the gas-liquid interface becomes higher than the gas-side pressure by 1 kPa.

The pressing mechanism 48 presses the diaphragm 56 to open the on-off valve 59 regardless of the pressure in the liquid inflow portion 50. In this case, the pressing mechanism 48 presses the diaphragm 56 with a pressing force larger than a pressing force generated when pressure obtained by adding the above-described predetermined value to the pressure at which the pressurizing mechanism 31 pressurizes the liquid is applied to the diaphragm 56.

Then, in the state where the on-off valve 59 is opened, the liquid pressurized by the pressurizing mechanism 31 is supplied to the liquid ejecting portion 12 by regularly driving the pressure reducing portion 43. That is, when the pressure in the negative pressure chamber 42 is reduced by driving of the pressure reducing portion 43, the flexible member 37 moves in the direction in which the volume of the pump chamber 41 is increased.

Then, the liquid flows from the liquid supply source 13 into the pump chamber 41. When the pressure reduction by the pressure reducing portion 43 is released, the flexible member 37 is biased by the biasing force of the biasing member 44 in the direction in which the volume of the pump chamber 41 is decreased. That is, the liquid in the pump chamber 41 is pressurized by the biasing force of the biasing member 44 through the flexible member 37, passes through the second one-way valve 40, and is supplied to the downstream of the liquid supply flow path 27.

The valve opened state of the on-off valve 59 is maintained during a period in which the pressing mechanism 48 presses the diaphragm 56. Thus, when the pressurizing mechanism 31 pressurizes the liquid in this state, pressurized cleaning being the discharge operation of discharging the liquid from the nozzle 19 by the pressurizing force being transmitted to the liquid ejecting portion 12 through the liquid inflow portion 50, the communication path 57, and the liquid outflow portion 51 is performed. As illustrated in FIG. 7, when the discharge operation is performed, the control portion 180 moves the carriage 124 such that the first liquid ejecting portion 12A faces the first liquid receiving portion 131 in advance and the second liquid ejecting portion 12B faces the second liquid receiving portion 132. That is, the control portion 180 performs the discharge operation in a state where the liquid ejecting portion 12 is stopped at the pressurized cleaning position CP. Accordingly, the first liquid receiving portion 131 receives the liquid discharged from the nozzle 19 of the first liquid ejecting portion 12A, and the second liquid receiving portion 132 receives the liquid discharged from the nozzle 19 of the second liquid ejecting portion 12B.

Then, the discharge stop operation of stopping the discharge operation is performed. In the discharge stop operation, the pressing of the pressing mechanism 48 on the diaphragm 56 is released, and the on-off valve 59 is closed. Thus, the upstream and the downstream of the pressure adjusting mechanism 35 do not communicate with each other, and thus the pressurized liquid is not supplied from the liquid supply source 13 to the liquid ejecting portion 12. In the first embodiment, the discharge operation and the discharge stop operation are repeated in a short cycle. Thus, in the discharge operation, the decrease in the flow velocity of the liquid flowing in the liquid supply flow path 27 and the liquid ejecting portion 12 is suppressed, and it is easy to remove foreign matters such as air bubbles from the liquid supply flow path 27 and the liquid ejecting portion 12.

The liquid discharged from the nozzle 19 by the pressurized cleaning wets and spreads along the nozzle surface 18. When the amount of the liquid adhering to the nozzle surface 18 becomes greater than the amount of the liquid enabled to be held by the nozzle surface 18, the liquid drops from the nozzle surface 18. Therefore, a large amount of liquid adheres to the nozzle surface 18 after the discharge operation. For example, when the wiping operation is performed as it is after the discharge operation, there is a concern that it is not possible to wipe the liquid adhering to the nozzle surface 18 by the wiping portion 161 and the liquid remains on the nozzle surface 18.

After the discharge operation and before the wiping operation in which the wiping portion 161 wipes the nozzle surface 18, the control portion 180 performs the acceleration operation of moving the liquid ejecting portion 12 and the stop operation of stopping the liquid ejecting portion 12. The control portion 180 performs the acceleration operation and the stop operation to apply an inertial force to the liquid adhering to the nozzle surface 18. That is, the liquid adhering to the nozzle surface 18 is shaken off from the nozzle surface 18 with the acceleration operation and the stop operation, and thus the amount of the liquid adhering to the nozzle surface 18 is reduced.

Specifically, the acceleration operation is an operation of accelerating the liquid ejecting portion 12 by moving the liquid ejecting portion 12 stopped at the pressurized cleaning position CP, in the scanning direction Xs. The acceleration during the acceleration operation may be larger than the acceleration during the printing operation. The control portion 180 moves the stopped liquid ejecting portion 12 to the wiping region WA in the acceleration operation. With the acceleration operation, the liquid dropped from the nozzle surface 18 of the first liquid ejecting portion 12A is received by the first liquid receiving portion 131, and the liquid dropped from the nozzle surface 18 of the second liquid ejecting portion 12B is received by the second liquid receiving portion 132.

Then, the control portion 180 performs the stop operation to stop the liquid ejecting portion 12 moving with the acceleration operation, in the wiping region WA. The deceleration that is the negative acceleration during the stop operation may be greater than the deceleration during the printing operation. The control portion 180 performs the stop operation in a state where the holding portion 142 is located at the receiving position illustrated in FIG. 2.

When the holding portion 142 is located at the receiving position, the pull-out portion 162 is located at a position vertically below the moving region of the first liquid ejecting portion 12A. The wiping portion 161 is located between the moving region of the first liquid ejecting portion 12A and the moving region of the second liquid ejecting portion 12B in the transport direction Yf. Therefore, when the liquid ejecting portion 12 stops in the wiping region WA, the nozzle surface 18 of the first liquid ejecting portion 12A faces the pull-out portion 162. The nozzle surface 18 of the second liquid ejecting portion 12B faces the waste liquid pan 138 through the through-hole 149. The wiping portion 161 is located between the first liquid ejecting portion 12A and the second liquid ejecting portion 12B. In other words, the control portion 180 stops the liquid ejecting portion 12 at a position at which the nozzle surface 18 of the first liquid ejecting portion 12A faces the pull-out portion 162 and the wiping portion 161 is not in contact with the nozzle surfaces 18 of the first liquid ejecting portion 12A and the second liquid ejecting portion 12B, in the stop operation.

Since the pull-out portion 162 is located vertically below the first liquid ejecting portion 12A stopped in the wiping region WA, the liquid dropped from the nozzle surface 18 of the first liquid ejecting portion 12A by the stop operation is received by the pull-out portion 162. Since the through-hole 149 and the waste liquid pan 138 are located vertically below the second liquid ejecting portion 12B stopped in the wiping region WA, the liquid dropped from the nozzle surface 18 of the second liquid ejecting portion 12B by the stop operation passes through the through-hole 149 and is received by the waste liquid pan 138. When the liquid adhering to the nozzle surface 18 is shaken off by the acceleration operation and the stop operation and the amount of the liquid adhering to the nozzle surface 18 is reduced, the control portion 180 performs the wiping operation.

As illustrated in FIG. 8, in the wiping operation, wiping is performed in a state where the wiping portion 161 is brought into contact with the nozzle surface 18 of the liquid ejecting portion 12. In this manner, the liquid adhering to the nozzle surface 18 of the liquid ejecting portion 12 is removed, and a normal meniscus is formed in the nozzle 19 of the liquid ejecting portion 12.

Next, a method of manufacturing the pressure adjusting device 47 in the first embodiment will be described.

Firstly, the main body portion 52 in the first embodiment is formed of light absorbing resin that absorbs laser light and generates heat, or resin that is colored with a dye that absorbs light. Examples of the light absorbing resin include polypropylene and polybutylene terephthalate. The diaphragm 56 is formed by laminating different materials such as polypropylene and polyethylene terephthalate, and has flexibility and transparency for transmitting laser light. The pressing member 68 is formed of light transmissive resin that transmits laser light. Examples of the light transmissive resin include polystyrene and polycarbonate. That is, the degree of the transparency of the diaphragm 56 is higher than that of the main body portion 52 and is lower than that of the pressing member 68.

As illustrated in FIG. 4, firstly, the manufacturing method includes a nipping step in which the diaphragm 56 is nipped by the main body portion 52 and the pressing member 68 that inserts a portion of the expansion and contraction portion 67 into the insertion hole 70. The manufacturing method includes an irradiation step of performing irradiation with laser light through the pressing member 68. Then, the main body portion 52 absorbs the laser light transmitted through the pressing member 68 and generates heat. With the heat generated at this time, the main body portion 52, the diaphragm 56, and the pressing member 68 are welded. Thus, the pressing member 68 also functions as a jig for pressing the diaphragm 56 when the pressure adjusting device 47 is manufactured.

The effects of this embodiment will be described.

1. The control portion 180 performs the acceleration operation of moving the liquid ejecting portion 12 after the discharge operation and before the wiping operation. Therefore, the liquid adhering to the nozzle surface 18 by the discharge operation easily drops due to the inertial force generated by the acceleration operation. Thus, it is possible to reduce the liquid adhering to the liquid ejecting portion 12 by dropping the liquid with the acceleration operation, and to wipe the nozzle surface 18 well in the wiping operation performed after the acceleration operation.

2. The control portion 180 stops the liquid ejecting portion 12 after the acceleration operation. That is, the control portion 180 can cause the liquid adhering to the liquid ejecting portion 12 to be easier to drip by decelerating and stopping the liquid ejecting portion 12 after the acceleration operation. The position where the liquid ejecting portion 12 is stopped is a position where the nozzle surface 18 is not in contact with the wiping portion 161. Therefore, the control portion 180 can perform the wiping operation on the liquid ejecting portion 12 in which the adhering liquid is reduced by acceleration and deceleration.

3. The control portion 180 stops the first liquid ejecting portion 12A at the position where the nozzle surface 18 and the pull-out portion 162 face each other. Therefore, it is possible to easily collect the liquid dropped when the first liquid ejecting portion 12A is stopped, by the pull-out portion 162.

4. The waste liquid pan 138 is provided vertically below the moving region of the liquid ejecting portion 12. Thus, even when the liquid is dropped in the middle of the liquid ejecting portion 12 moving, it is possible to collect the liquid by the waste liquid pan 138.

5. The through-hole 149 is provided vertically below the moving region of the second liquid ejecting portion 12B, and the waste liquid pan 138 is provided vertically below the through-hole 149. Thus, even when the wiping mechanism 133 is provided between the moving region and the waste liquid pan 138, it is possible to collect the liquid dropped from the second liquid ejecting portion 12B in the waste liquid pan 138 by causing the liquid to pass through the through-hole 149.

### Second Embodiment

Next, a liquid ejecting apparatus 11 in a second embodiment will be described with reference to the drawings.

In the second embodiment, the pressure adjusting device 47 in the first embodiment is changed to a pressure adjusting device 200 illustrated in FIGS. 9 and 10. In other points, the second embodiment is substantially the same as the first embodiment. Thus, the same members are denoted by the same reference signs, and repetitive descriptions will be omitted.

As illustrated in FIGS. 9 and 10, the pressure adjusting device 200 is formed by assembling an air chamber forming unit 201, a pressure adjusting mechanism forming unit 202, a bottom plate member 203, a connection portion forming unit 204, and two lever units 205.

The connection portion forming unit 204 includes a main body portion 206 and a connection film 207 attached to cover the outer surface of the main body portion 206. A first liquid connection portion 208, a second liquid connection portion 209, and a pressure connection portion 211 are provided to be projected on the upper surface of the main body portion 206. The first liquid connection portion 208 and the second liquid connection portion 209 are connected to two of the plurality of liquid supply flow paths 27, respectively. The pressure connection portion 211 is connected to the pressure adjusting portion 210. A first liquid outlet portion 212, a second liquid outlet portion 213, and a pressure supply portion 214 that respectively communicate with the first liquid connection portion 208, the second liquid connection portion 209, and the pressure connection portion 211 are provided to be projected on the inner surface of the main body portion 206.

Three grooves (not illustrated) are formed on the outer surface of the main body portion 206 of the connection portion forming unit 204. Three flow paths (not illustrated) are formed by the three grooves and the connection film 207. The three flow paths (not illustrated) connect the first liquid connection portion 208, the second liquid connection portion 209, and the pressure connection portion 211 with the first liquid outlet portion 212, the second liquid outlet portion 213, and the pressure supply portion 214.

The air chamber forming unit 201 includes a main body portion 215 and a flexible air chamber film 216 attached to both side surfaces of the main body portion 215 so as to cover the entirety of both the side surfaces. An air introduction portion 217 to which the pressure supply portion 214 is connected is provided on a side surface of the main body portion 215 on the connection portion forming unit 204 side. A substantially T-shaped attachment portion 218 to which the lever unit 205 is attached is provided to be projected in the vicinity of each of boundaries with the pressure adjusting mechanism forming unit 202 on both the side surfaces of the main body portion 215.

As illustrated in FIGS. 9 and 11, a circular recess portion 219 is formed on both the side surfaces of the main body portion 215 of the air chamber forming unit 201. The space surrounded by the recess portion 219 and the air chamber film 216 functions as a pressure adjustment chamber 220 that is an air chamber. A circular portion of the air chamber film 216, which corresponds to the recess portion 219 functions as a flexible wall 221 forming a portion of the pressure adjustment chamber 220. In the second embodiment, the flexible wall 221 constitutes a “turning force applying portion”.

As illustrated in FIGS. 12 and 13, respective grooves 222 are formed on both the side surfaces of the main body portion 215 of the air chamber forming unit 201. The grooves 222 communicate with each other by third communication holes 223. The two grooves 222 communicate with the central portion of the recess portion 219 located on the opposite side through a fourth communication hole 224. An air flow path 225 is formed by a space surrounded by the two grooves 222 and the two air chamber films 216. Thus, the air flow path 225 extends over both the side surfaces of the main body portion 215. The air flow path 225 communicates with the air introduction portion 217.

As illustrated in FIG. 9, the pressure adjusting mechanism forming unit 202 includes a main body portion 226 and flexible pressure films 227 attached to both side surfaces of the main body portion 226 to cover the entirety of both the side surfaces of the main body portion 226. A first liquid introduction portion 228 and a second liquid introduction portion 229, to which the first liquid outlet portion 212 and the second liquid outlet portion 213 are respectively connected, are provided on the side surface of the main body portion 226 on the connection portion forming unit 204 side.

As illustrated in FIGS. 9 and 11, a circular recess portion 230 is formed on both the side surfaces of the main body portion 226 of the pressure adjusting mechanism forming unit 202. The space surrounded by each recess portion 230 and each pressure film 227 functions as a liquid outflow portion 231. A circular portion of each pressure film 227, which corresponds to the recess portion 230 functions as a diaphragm 232 forming a portion of the liquid outflow portion 231.

As illustrated in FIGS. 9 and 13, the lever unit 205 includes a rectangular plate-like lever 233 and a torsion spring 235 locked by a locking portion 234 of the lever 233. An attachment hole 236 for attaching the lever unit 205 to the attachment portion 218 is formed to be penetrated at a position slightly closer to the one end side than the central portion of the lever 233 in a longitudinal direction. The lever 233 has a substantially disc-like pressing portion 237 at one end portion of the surface on one side in the longitudinal direction, and a substantially hemispherical pressed portion 238 at the other end portion.

When the lever unit 205 is attached to the attachment portion 218 in the attachment hole 236 of the lever 233, the lever unit 205 is turnable around a fulcrum which is a contact portion of the lever 233 with the attachment portion 218. At this time, the pressing portion 237 faces the central portion of the diaphragm 232, and the pressed portion 238 comes into contact with the central portion of the flexible wall 221.

At this time, the biasing force of the torsion spring 235 acts as a resistance force when the lever 233 is rotated in a direction in which the pressing portion 237 approaches the diaphragm 232. Thus, the pressing portion 237 is normally separated from the diaphragm 232.

As illustrated in FIG. 14, the pressure adjusting portion 210 includes an annular pipe 240, a pump 241 provided in the middle of the annular pipe 240, and a connection pipe 242 that is provided at a position on an opposite side of the pump 241 in the annular pipe 240 and connects the annular pipe 240 with the pressure connection portion 211. A second valve V2 is provided between the pump 241 and a connection position of the annular pipe 240 with the connection pipe 242. A third valve V3 is provided at a position on an opposite side of the second valve V2 in the annular pipe 240.

A base end side of a first branch pipe 243 having a tip end side which is open to the atmosphere is connected between the second valve V2 and the pump 241 in the annular pipe 240. A first valve V1 is provided at a position in the middle of the first branch pipe 243. A base end side of a second branch pipe 244 having a tip end side which is open to the atmosphere is connected between the third valve V3 and the pump 241 in the annular pipe 240. A fourth valve V4 is provided at a position in the middle of the second branch pipe 244.

The pump 241 drives to cause the air in the annular pipe 240 to flow in a direction indicated by an arrow in FIG. 14. The pressure adjusting portion 210 drives the pump 241 in a state where the first valve V1 and the third valve V3 are closed and the second valve V2 and the fourth valve V4 are opened, and thus supplies the pressurized air from the pressure connection portion 211 to pressurize the pressure adjustment chamber 220, as illustrated in FIGS. 10 and 11.

The pressure adjusting portion 210 drives the pump 241 in a state where the first valve V1 and the third valve V3 are opened and the second valve V2 and the fourth valve V4 are closed, and thus sucks the air from the pressure connection portion 211 to reduce the pressure in the pressure adjustment chamber 220, as illustrated in FIGS. 10 and 11.

Thus, the pressure adjusting portion 210 functions as a pressurizing and depressurizing device capable of simultaneously pressurizing or depressurizing the two pressure adjustment chambers 220 of the pressure adjusting device 200. The first valve V1 to the fourth valve V4 are configured by electromagnetic valves, and the opening and closing operations of the valves are controlled by the control portion 180.

Next, the pressure adjusting device 200 will be described in detail.

Here, description will be made mainly based on FIGS. 4 and 15, and description will be made on the assumption that the pressure adjusting device 47 in FIG. 4 is replaced with the pressure adjusting device 200 illustrated in FIG. 15.

As illustrated in FIGS. 4 and 15, the pressure adjusting device 200 includes two pressure adjusting mechanisms 250 that are provided in the liquid supply flow path 27 and constitute a portion of the liquid supply flow path 27, and two pressing mechanisms 251 that press the pressure adjusting mechanism 250. Thus, the one pressure adjusting device 200 is capable of adjusting the pressure of two types of liquid.

The pressure adjusting mechanism 250 in the pressure adjusting mechanism forming unit 202 includes a main body portion 226 in which a liquid inflow portion 252 into which the liquid to be supplied from the liquid supply source 13 through the liquid supply flow path 27 flows, and a liquid outflow portion 231 capable of accommodating the liquid are formed. The liquid supply flow path 27 and the liquid inflow portion 252 are partitioned by a wall portion 247, and communicate with each other through a fifth communication hole 248 formed in the wall portion 247. A filter member 249 is disposed on an immediately upstream of the fifth communication hole 248 in the liquid supply flow path 27. Thus, the liquid in the liquid supply flow path 27 is filtered by the filter member 249 and then flows into the liquid inflow portion 252.

A portion of a wall surface of the liquid outflow portion 231 is configured by a diaphragm 232. The diaphragm 232 receives the pressure of the liquid in the liquid outflow portion 231 at a first surface 232a being the inner surface of the liquid outflow portion 231, and receives the atmospheric pressure at a second surface 232b being the outer surface of the liquid outflow portion 231.

Therefore, the diaphragm 232 performs displacement in accordance with the pressure inside the liquid outflow portion 231. Thus, the volume of the liquid outflow portion 231 changes by the displacement of the diaphragm 232. The liquid inflow portion 252 and the liquid outflow portion 231 communicate with each other by a communication path 254.

The pressure adjusting mechanism 250 includes an on-off valve 255 capable of switching the state between the valve closed state and the valve opened state. The valve closed state illustrated in FIG. 15 is a state where the liquid inflow portion 252 and the liquid outflow portion 231 are not in communication with each other in the communication path 254. The valve opened state illustrated in FIG. 16 is a state where the liquid inflow portion 252 and the liquid outflow portion 231 are in communication with each other.

The on-off valve 255 includes a valve portion 256 capable of blocking the communication path 254, and a rod portion 257 inserted into the communication path 254. The rod portion 257 is in contact with a substantially disk-like pressure receiving portion 258 disposed such that the tip of the rod portion 257 comes into contact with the central portion of the first surface 232a of the diaphragm 232. In this case, the pressure receiving portion 258 may be fixed to the tip of the rod portion 257 or may be fixed to the central portion of the first surface 232a of the diaphragm 232.

The on-off valve 255 moves by being pressed by the diaphragm 232 through the pressure receiving portion 258. That is, the pressure receiving portion 258 also functions as a moving member that is movable in a state of being in contact with the diaphragm 56 that performs displacement in a direction in which the volume of the liquid outflow portion 231 is reduced.

An upstream biasing member 259 is provided in the liquid inflow portion 252, and a downstream biasing member 260 is provided in the liquid outflow portion 231. The upstream biasing member 259 biases the on-off valve 255 to be closed, and the downstream biasing member 260 biases the pressure receiving portion 258 in a direction of being pressed on the diaphragm 232. When pressure applied to the first surface 232a is lower than pressure applied to the second surface 232b, and a difference between the pressure applied to the first surface 232a and the pressure applied to the second surface 232b is equal to or greater than a predetermined value, the on-off valve 255 turns from the valve closed state into the valve opened state. The predetermined value is, for example, 1 kPa.

The predetermined value is a value determined in accordance with a biasing force of the upstream biasing member 259, a biasing force of the downstream biasing member 260, a force required for causing the diaphragm 232 to perform displacement, a seal load, pressure in the liquid inflow portion 252, which acts on the surface of the valve portion 256, and pressure in the liquid outflow portion 231. The seal load is a pressing force required for blocking the communication path 254 by the valve portion 256. That is, the predetermined value increases as the biasing forces of the upstream biasing member 259 and the downstream biasing member 260 increase.

The biasing forces of the upstream biasing member 259 and the downstream biasing member 260 are set such that the pressure in the liquid outflow portion 231 is in a negative pressure state in a range where a meniscus can be formed at a gas-liquid interface in the nozzle 19. When the pressure applied to the second surface 232b is atmospheric pressure, the pressure in the liquid outflow portion 231 is set to be −1 kPa, for example. In this case, the gas-liquid interface is a boundary at which the liquid and the gas are in contact with each other, and the meniscus is a curved liquid surface formed in a manner that the liquid comes into contact with the nozzle 19. Preferably, a recessed meniscus suitable for ejecting the liquid is formed in the nozzle 19.

The pressing mechanism 251 includes a lever 233, a pressure adjustment chamber 220 having a flexible wall 221 of applying a turning force to the lever 233, and a pressure adjusting portion 210. The lever 233 includes a pressing portion 237 capable of pressing the second surface 232b side of the diaphragm 232 and is turnable. The pressure adjusting portion 210 is capable of adjusting the pressure in the pressure adjustment chamber 220 and is illustrated in FIG. 10. The flexible wall 221 swells or dents while the pressure in the pressure adjustment chamber 220 is adjusted by the pressure adjusting portion 210.

Since the pressure adjusting portion 210 adjusts the pressure in the pressure adjustment chamber 220 to be higher than the atmospheric pressure, so as to swell the flexible wall 221, the pressing mechanism 251 causes the on-off valve 255 to be opened, in a manner that the diaphragm 232 is pressed by the pressing portion 237 of the lever 233 in the direction in which the volume of the liquid outflow portion 231 is reduced.

That is, when the flexible wall 221 swells in a state of being in contact with the pressed portion 238 of the lever 233, the pressed portion 238 is pressed by the flexible wall 221 to apply a rotation force to the lever 233, and the turning force causes the lever 233 to rotate around a fulcrum being a contact portion with the attachment portion 218.

Since, with the rotation of the lever 233, the pressing portion 237 presses the second surface 232b side of the diaphragm 232 in the direction in which the volume of the liquid outflow portion 231 decreases, the on-off valve 255 turns from the valve closed state into the valve opened state. At this time, the pressing portion 237 of the pressing mechanism 251 presses a region of the diaphragm 232, which is in contact with the pressure receiving portion 258. In this case, the area of the region of the diaphragm 232, which is in contact with the pressure receiving portion 258 is larger than the cross-sectional area of the communication path 254.

In the pressing mechanism 251, the pressure adjusting portion 210 adjusts the pressure in the pressure adjustment chamber 220 to pressure lower than the pressure in the pressure adjustment chamber 220 when the diaphragm 232 is pressed by the pressing portion 237 of the lever 233. Thus, pressing of the diaphragm 232 by the pressing portion 237 of the lever 233 is released. The pressing portion 237 is separated from the diaphragm 232 in a state where the turning force by the flexible wall 221 is not applied to the lever 233.

The action in the second embodiment will be described.

When the liquid ejecting portion 12 ejects the liquid, the liquid accommodated in the liquid outflow portion 231 is supplied to the liquid ejecting portion 12 through the liquid supply flow path 27. Then, the pressure in the liquid outflow portion 231 decreases. When the difference between the pressure applied to the first surface 232a and the pressure applied to the second surface 232b of the diaphragm 232 becomes equal to or greater than the predetermined value, the diaphragm 232 deforms to be bent in the direction in which the volume of the liquid outflow portion 231 is reduced. The on-off valve 255 is pressed and moves through the pressure receiving portion 258 by the deformation of the diaphragm 232, and the on-off valve 255 is opened.

When the on-off valve 255 is opened, the liquid in the liquid inflow portion 252 is pressurized by the pressurizing mechanism 31. Thus, the liquid is supplied from the liquid inflow portion 252 to the liquid outflow portion 231, and the pressure in the liquid outflow portion 231 rises. Thus, the diaphragm 232 deforms to increase the volume of the liquid outflow portion 231. When the difference between the pressure applied to the first surface 232a of the diaphragm 232 and the pressure applied to the second surface 232b of the diaphragm 232 becomes smaller than the predetermined value, the on-off valve 255 moves by the biasing force of the upstream biasing member 259, turns from the valve opened state to the valve closed state, and inhibits the flowing of the liquid.

In this manner, the pressure adjusting mechanism 250 adjusts the pressure in the liquid ejecting portion 12, which is the back pressure of the nozzle 19, by causing the diaphragm 232 to perform displacement and adjusting the pressure of the liquid to be supplied to the liquid ejecting portion 12.

Next, an operation when the liquid ejecting apparatus 11 performs cleaning in the second embodiment will be described. In the cleaning in the second embodiment, it is assumed that the discharge operation and the discharge stop operation are not repeated.

As illustrated in FIG. 14, the control portion 180 drives the pump 241 in a state where the first valve V1 and the third valve V3 of the pressure adjusting portion 210 are closed and the second valve V2 and the fourth valve V4 are opened.

As illustrated in FIG. 16, the pressure in the pressure adjustment chamber 220 to which the air is pressurized and supplied from the pressure connection portion 211 is adjusted to the pressure higher than atmospheric pressure. Thus, the flexible wall 221 swells and presses the pressed portion 238 of the lever 233, and the lever 233 rotates around a fulcrum that is a contact portion with the attachment portion 218 against the biasing force of the torsion spring 235.

Then, the pressing portion 237 of the lever 233 presses the region of the diaphragm 232 with which the pressure receiving portion 258 is in contact, against the biasing force of the downstream biasing member 260. Then, the on-off valve 255 receives a pressing force by the pressing portion 237 over the diaphragm 232 and the pressure receiving portion 258 and moves against the biasing force of the upstream biasing member 259. Thus, the on-off valve 255 is opened.

That is, the pressing mechanism 251 moves the pressure receiving portion 258 and the on-off valve 255 against the biasing forces of the upstream biasing member 259 and the downstream biasing member 260, thereby opening the on-off valve 255. In this case, since the pressure adjusting portions 210 are connected to the pressure connection portion 211 of the plurality of pressure adjusting devices 200, the on-off valves 255 of all the pressure adjusting devices 200 are opened.

At this time, the diaphragm 232 is deformed in the direction in which the volume of the liquid outflow portion 231 is reduced. Thus, the liquid accommodated in the liquid outflow portion 231 is pressed to the liquid ejecting portion 12 side. That is, the pressure at which the diaphragm 232 presses on the liquid outflow portion 231 is transmitted to the liquid ejecting portion 12, and thus, the meniscus is broken and the liquid overflows from the nozzle 19.

That is, the pressing mechanism 251 presses the diaphragm 232 such that the pressure in the liquid outflow portion 231 becomes higher than the pressure at which at least one meniscus is broken. For example, the pressure at which the meniscus is broken is pressure at which the liquid-side pressure at the gas-liquid interface becomes higher than the gas-side pressure by 1 kPa.

The pressing mechanism 251 presses the diaphragm 232 to open the on-off valve 255 regardless of the pressure in the liquid inflow portion 252. In this case, the pressing mechanism 251 presses the diaphragm 232 with a pressing force larger than a pressing force generated when pressure obtained by adding the above-described predetermined value to the pressure at which the pressurizing mechanism 31 pressurizes the liquid is applied to the diaphragm 232.

Then, in the open state of the on-off valve 255 by the pressing mechanism 251 pressing the diaphragm 232, the control portion 180 drives the pressure reducing portion 43 periodically, such that the predetermined amount of liquid pressurized by the pressurizing mechanism 31 is supplied to the liquid ejecting portion 12. That is, when the pressure in the negative pressure chamber 42 is reduced by driving of the pressure reducing portion 43, the flexible member 37 moves in the direction in which the volume of the pump chamber 41 is increased.

Then, the liquid flows from the liquid supply source 13 into the pump chamber 41. When the pressure reduction by the pressure reducing portion 43 is released, the flexible member 37 is biased by the biasing force of the biasing member 44 in the direction in which the volume of the pump chamber 41 is decreased. That is, the predetermined amount of the liquid in the pump chamber 41 is pressurized by the biasing force of the biasing member 44 through the flexible member 37, passes through the second one-way valve 40, is sent to the downstream of the liquid supply flow path 27, and then is supplied to liquid ejecting portion 12.

The valve opened state of the on-off valve 255 is maintained during a period in which the pressing mechanism 251 presses the diaphragm 232. Thus, when the pressurizing mechanism 31 pressurizes the predetermined amount of the liquid in this state, pressurized cleaning being the discharge operation of discharging the liquid from the nozzle 19 by the pressurizing force being transmitted to the liquid ejecting portion 12 through the liquid inflow portion 252, the communication path 254, and the liquid outflow portion 231 is performed. That is, since the pressurizing mechanism 31 pressurizes the liquid, the predetermined amount of the pressurized liquid is supplied to the liquid ejecting portion 12, and then is discharged from the nozzle 19 to the first liquid receiving portion 131 and the second liquid receiving portion 132.

When the predetermined amount of liquid is discharged from the nozzle 19, the discharge of the liquid from the nozzle 19 is stopped. That is, when the pressurizing mechanism 31 discharges the predetermined amount of pressurized liquid from the nozzle 19, the pressurization level of the liquid supplied with the discharge of the liquid decreases, and thus reaches a pressurization level at which the liquid is not discharged from the nozzle 19.

Then, since the first valve V1 and the third valve V3 of the pressure adjusting portion 210 are opened and the second valve V2 and the fourth valve V4 are closed, the air is sucked from the pressure connection portion 211 and thus the pressure in the pressure adjustment chamber 220 is reduced.

Thus, the swollen flexible wall 221 is shrunk and is recessed. Then, the lever 233 is rotated by the biasing force of the torsion spring 235 with the fulcrum which is the contact portion with the attachment portion 218, as the rotation center, and thus returns to the original position. That is, the pressing portion 237 of the lever 233 is separated from the diaphragm 232.

Then, the diaphragm 232 returns to the original position by the biasing force of the downstream biasing member 260 together with the pressure receiving portion 258, and the on-off valve 255 moves by the biasing force of the upstream biasing member 259 to be in the closed state. In this manner, the upstream on which the pressurizing mechanism 31 is provided and the downstream on which the liquid ejecting portion 12 is provided do not communicate with each other by the on-off valve 255, and it is not possible to supply the pressurized liquid to the liquid ejecting portion 12. Thus, the discharge stop operation is performed.

After the discharge stop operation, a large amount of liquid is adhered to the nozzle surface 18 of the liquid ejecting portion 12. Therefore, the control portion 180 performs the acceleration operation and the stop operation, similar to the first embodiment. Then, the control portion 180 performs the wiping operation, and thus the normal meniscus is formed in the nozzle 19 of the liquid ejecting portion 12.

The effects of this embodiment will be described.

6. In the liquid ejecting apparatus 11, the pressing mechanism 251 rotates the lever 233 in a manner that the pressure adjusting portion 210 adjusts the pressure in the pressure adjustment chamber 220 and applies the turning force to the lever 233 by the flexible wall 221. Thus, the pressing portion 237 presses the diaphragm 232 on the second surface 232b side. Therefore, only by changing the specifications of the lever 233 such as the lever ratio and the shape, it is possible to change the pressing force by the pressing portion 237 without changing the specifications of the pressure adjustment chamber 220 such as the pressurizing force and the size. That is, even though the pressing force required by the pressing portion 237 changes, it is possible to handle the change of the pressing force without changing the specifications of the pressure adjustment chamber 220, only by changing the specifications of the lever 233. Accordingly, it is possible to improve the versatility.

7. In the liquid ejecting apparatus 11, the pressing portion 237 is separated from the diaphragm 232 in a state where the turning force by the flexible wall 221 is not applied to the lever 233. Therefore, it is possible to suppress the occurrence of malfunction of the pressure adjusting mechanism 250 due to the pressing portion 237 of the lever 233 coming into contact with the diaphragm 232.

8. In the liquid ejecting apparatus 11, the pressing mechanism 251 presses the region of the diaphragm 232 with which the pressure receiving portion 258 is in contact, by the pressing portion 237 of the lever 233. Therefore, it is possible to press the diaphragm 232 by the pressing portion 237 such that the outer region of the diaphragm 232, which is the region around the pressure receiving portion 258, is not deformed into the liquid outflow portion 231. Thus, after the pressing of the diaphragm 232 by the pressing portion 237 is released, the outer region of the pressure receiving portion 258 of the diaphragm 232 moves in the direction in which the volume of the liquid outflow portion 231 increases and returns to the state before the pressing. Accordingly, it is possible to suppress the air bubbles and the liquid from being drawn from the nozzle 19.

9. In the liquid ejecting apparatus 11, the pressing mechanism 251 presses the diaphragm 232 by the pressing portion 237 of the lever 233 in a manner that the pressure adjusting portion 210 adjusts the pressure in the pressure adjustment chamber 220 to pressure higher than the atmospheric pressure. Therefore, it is possible to press the diaphragm 232 by the pressing portion 237 of the lever 233, only by adjusting the pressure in the pressure adjustment chamber 220 to pressure higher than the atmospheric pressure.

10. In the liquid ejecting apparatus 11, in the pressing mechanism 251, the pressure adjusting portion 210 adjusts the pressure in the pressure adjustment chamber 220 to pressure lower than the pressure in the pressure adjustment chamber 220 when the diaphragm 232 is pressed by the pressing portion 237. Thus, pressing of the diaphragm 232 by the pressing portion 237 of the lever 233 is released. Therefore, it is possible to easily release the pressed state of the diaphragm 232 by the pressing portion 237 of the lever 233.

11. In the liquid ejecting apparatus 11, the turning force applying portion is the flexible wall 221 that forms a portion of the pressure adjustment chamber 220, and applies the turning force to the lever 233 by coming into contact with the lever 233. Therefore, it is possible to cause the flexible wall 221 that forms the portion of the pressure adjustment chamber 220 to suitably function as the turning force applying portion that applies the turning force to the lever 233.

12. In the liquid ejecting apparatus 11, the pressurizing mechanism 31 pressurizes the liquid in the open state of the on-off valve 255 by the pressing mechanism 251 pressing the diaphragm 232, and thus the pressurized liquid is supplied to the liquid ejecting portion 12. Therefore, it is possible to perform the discharge operation of supplying the pressurized liquid to the liquid ejecting portion 12 and discharging the liquid from the nozzle 19 by pressurizing the liquid with the pressurizing mechanism 31 in a state where the on-off valve 255 is forcibly opened.

13. In the liquid ejecting apparatus 11, in a state where the liquid is pressurized by the pressurizing mechanism 31, the pressing of the diaphragm 232 by the pressing mechanism 251 is released and thus the on-off valve 255 is closed. Therefore, it is possible to suppress air bubbles or the liquid from being drawn from the nozzle 19 after the pressurized cleaning.

The second embodiment may be modified and implemented as follows. The second embodiment and the following modification examples may be implemented in combination with each other in a range without technical contradiction.

As illustrated in FIG. 17, the liquid ejecting apparatus 11 may be a liquid ejecting apparatus 11A that does not include the pressure adjusting mechanism 35. The liquid ejecting apparatus 11A includes a main tank 301 as an example of the liquid supply source that stores a liquid, a sub-tank 302 that stores the liquid supplied from the main tank 301, and a liquid ejecting portion 12 that ejects the liquid. The liquid ejecting apparatus 11A further includes a first flow path 311 of connecting the main tank 301 and the sub-tank 302, and a second flow path 312 and a third flow path 313 that individually connect the sub-tank 302 and the liquid ejecting portion 12 to each other. The liquid ejecting apparatus 11A further includes a first supply pump 321 and a second supply pump 322. The first supply pump 321 is disposed in the first flow path 311 and cause the liquid to flow from the main tank 301 to the sub-tank 302. The second supply pump 322 is disposed in the second flow path 312 and causes the liquid to flow from the sub-tank 302 to the liquid ejecting portion 12. The liquid ejecting apparatus 11A further includes an atmosphere opening valve 331 and a switch valve 332. The atmosphere opening valve 331 is connected to the sub-tank 302 and switches a communication state of the inside of the sub-tank 302 with the outer air. The switch valve 332 is disposed in the third flow path 313 and permits or regulates the flowing of the liquid.

In the liquid ejecting apparatus 11A, the position relation between the sub-tank 302 and the liquid ejecting portion 12 in the vertical direction Z is a position relation in which the pressure in the liquid ejecting portion 12, more specifically, the pressure in the nozzle 19 may be maintained to be negative pressure by a water level difference between the liquid surface of the sub-tank 302 and the liquid surface of the nozzle 19 in the liquid ejecting portion 12.

In the liquid ejecting apparatus 11A, when performing the printing operation, the liquid is ejected from the nozzle 19 of the liquid ejecting portion 12 based on the driving of the actuator 24. During the printing operation, since the switch valve 332 is opened, the liquid of an amount corresponding to the amount of the liquid ejected from the liquid ejecting portion 12 is supplied from the sub-tank 302. When the amount of liquid stored in the sub-tank 302 decreases by continuing the printing operation, the first supply pump 321 is driven, and the liquid is supplied from the main tank 301 to the sub-tank 302. During the printing operation, the atmosphere opening valve 331 is opened to the atmosphere, and the second supply pump 322 is stopped.

In the liquid ejecting apparatus 11A, when performing the discharge operation, the second supply pump 322 is driven in a state where the switch valve 332 is closed. Therefore, the liquid pressurized in the liquid ejecting portion 12 is supplied through the second flow path 312, and thus the liquid is discharged from the nozzle 19 of the liquid ejecting portion 12.

As illustrated in FIG. 18, the liquid ejecting apparatus 11 may be a liquid ejecting apparatus 11B that includes the pressure adjusting mechanism 35. The liquid ejecting apparatus 11B includes a main tank 401 as an example of the liquid supply source that stores a liquid, a sub-tank 402 that stores the liquid supplied from the main tank 401, and a liquid ejecting portion 12 that ejects the liquid. The liquid ejecting apparatus 11B further includes a first flow path 411 of connecting the main tank 401 and the sub-tank 402, a second flow path 412 of connecting the sub-tank 402 and the liquid ejecting portion 12, and a third flow path 413 connected to the sub-tank 402 at a position higher than the liquid surface of the sub-tank 402. The liquid ejecting apparatus 11B includes a supply pump 421, a pressure adjustment pump 422, and a pressure detection portion 423. The supply pump 421 is disposed in the first flow path 411 and causes the liquid to flow from the main tank 401 to the sub-tank 402. The pressure adjustment pump 422 is disposed in the third flow path 413 and adjusts the pressure in the sub-tank 402. The pressure detection portion 423 detects the pressure in the sub-tank 402. The liquid ejecting apparatus 11B further includes a first switch valve 431 that switches the communication state between the main tank 401 and the sub-tank 402, a second switch valve 432 that switches the communication state between the sub-tank 402 and the liquid ejecting portion 12, and a three-way valve 433 that switches the connection state between the sub-tank 402, the pressure adjustment pump 422, and the air. The first switch valve 431 is disposed in the first flow path 411. The second switch valve 432 is disposed in the second flow path 412. The three-way valve 433 is disposed in the third flow path 413.

In the liquid ejecting apparatus 11B, when performing the printing operation, the liquid is ejected from the nozzle 19 of the liquid ejecting portion 12, based on the driving of the actuator 24. During the printing operation, the three-way valve 433 is switched such that the sub-tank 402 and the pressure adjustment pump 422 communicate with each other. Since the first switch valve 431 is closed, the main tank 401 and the sub-tank 402 are brought into a non-connection state. Then, the pressure adjustment pump 422 is driven based on the detection result of the pressure detection portion 423 such that the sub-tank 402 has predetermined pressure. Thus, during the printing operation, the liquid is supplied to the liquid ejecting portion 12 while maintaining the pressure in the nozzle 19 of the liquid ejecting portion 12 to be predetermined negative pressure. When the amount of liquid stored in the sub-tank 402 is reduced by continuing the printing operation, the supply pump 421 is driven and the liquid is supplied from the main tank 401 to the sub-tank 402. When the liquid is supplied to the sub-tank 402, the first switch valve 431 is opened, the second switch valve 432 is closed, and the three-way valve 433 is switched such that the inside of the sub-tank 402 communicates with the atmosphere.

In the liquid ejecting apparatus 11B, when performing the discharge operation, the three-way valve 433 is switched such that the sub-tank 402 does not communicate with the atmosphere and the pressure adjustment pump 422. The sub-tank 402 and the liquid ejecting portion 12 are connected by the second switch valve 432 opening. The supply pump 421 is driven in a state where the first switch valve 431 is opened, and the pressurized liquid is supplied to the liquid ejecting portion 12 through the sub-tank 402. In this manner, the liquid is discharged from the liquid ejecting portion 12.

The liquid ejecting apparatus 11B may perform the discharge operation as follows. That is, when performing the discharge operation, the three-way valve 433 is switched such that the sub-tank 402 and the pressure adjustment pump 422 communicate with each other. Since the first switch valve 431 is closed, the main tank 401 and the sub-tank 402 are brought into a non-connection state. By driving the pressure adjustment pump 422, a gas is delivered into the sub-tank 402 and the inside of the sub-tank 402 is pressurized. In this manner, the pressurized liquid is supplied to the liquid ejecting portion 12, and the liquid is discharged from the liquid ejecting portion 12.

As illustrated in FIG. 19, in the wiping mechanism 133, the pull-out portion 162 and the wiping portion 161 may be disposed side by side in the scanning direction Xs. The control portion 180 performs the pressurized cleaning as the discharge operation, in a state where the liquid ejecting portion 12 is stopped at the pressurized cleaning position CP. Then, the control portion 180 sequentially performs the acceleration operation and the stop operation, moves the liquid ejecting portion 12 in the scanning direction Xs, and stops the liquid ejecting portion 12 at a position facing the pull-out portion 162. The control portion 180 may perform the acceleration operation again to move the liquid ejecting portion 12 in the scanning direction Xs and pass by the wiping region WA. The wiping region WA is a region in which the nozzle surface 18 of the liquid ejecting portion 12 moving in the scanning direction Xs comes into contact with the wiping portion 161. The nozzle surface 18 of the liquid ejecting portion 12 is wiped by passing through the wiping region WA. Thus, the control portion 180 may sequentially perform the discharge operation, the acceleration operation, the stop operation, the acceleration operation, and the wiping operation. By performing the acceleration operation a plurality of times, it is possible to further reduce the liquid that adheres to the nozzle surface 18.

When performing the acceleration operation a plurality of times, the control portion 180 may accelerate the liquid ejecting portion 12 in a different direction for each acceleration operation. For example, the control portion 180 may move the liquid ejecting portion 12 in the scanning direction Xs by the acceleration operation and the stop operation, and then may move the liquid ejecting portion 12 in the direction opposite to the scanning direction Xs in the subsequent acceleration operation. It is possible to more reduce the liquid adhering to the nozzle surface 18 by moving the liquid ejecting portion 12 in the opposite direction immediately after the stop operation is performed.

As illustrated in FIG. 19, the control portion 180 may sequentially perform the discharge operation, the acceleration operation, and the wiping operation. That is, the control portion 180 may perform the pressurized cleaning as the discharge operation in the stopped state at the pressurized cleaning position CP, and then move the liquid ejecting portion 12 in the scanning direction Xs with the acceleration operation, and cause the liquid ejecting portion 12 to pass by the wiping region WA. The control portion 180 may reduce the liquid adhering to the nozzle surface 18 by the acceleration operation and directly perform the wiping operation.

As illustrated in FIG. 19, the control portion 180 may perform the discharge operation in a state where the liquid ejecting portion 12 is located above the pull-out portion 162. That is, the pull-out portion 162 may function as the liquid receiving portion. In this case, the maintenance unit 130 may have a configuration of not including the first liquid receiving portion 131 and the second liquid receiving portion 132. The pull-out portion 162 may receive the liquid ejected by flushing.

When the liquid ejecting portion 12 is moved to perform the wiping operation, the wiping mechanism 133 may have a configuration of not including the base portion 143 and the rail 144. That is, the holding portion 142 may be arranged immovably.

The wiping portion 161 may be formed of an elastic member such as rubber that does not absorb liquid.

The wiping mechanism 133 may include a cleaning member that performs cleaning of the liquid adhering to the rail 144. The cleaning member may be provided on the holding portion 142 and may perform cleaning of the rail 144 by moving of the holding portion 142.

In the flowchart illustrated in FIG. 6, the control portion 180 may perform flushing after performing the wiping operation. According to this, it is possible to easily form a normal meniscus in the nozzle 19 of the liquid ejecting portion 12.

In the flowchart illustrated in FIG. 6, the control portion 180 may drive the actuator 24 after the discharge stop operation and before the wiping operation. According to this, in a state where the pressure in the liquid ejecting portion 12 is high and the gas-liquid interface in the nozzle 19 is unstable, the actuator 24 is driven to break the gas-liquid interface. Thus, it is possible to reduce the pressure in the liquid ejecting portion 12 by discharging the liquid from the nozzle 19.

In the flowchart illustrated in FIG. 6, the control portion 180 may drive the actuator 24 to perform flushing after the discharge stop operation and before the wiping operation. According to this, in a state where the pressure in the liquid ejecting portion 12 is high, it is possible to decrease the pressure in the liquid ejecting portion 12 by performing flushing and discharging the liquid from the nozzle 19. In this case, pre-wiping flushing performed before the wiping operation may be different from normal flushing of driving the actuator 24 after the wiping operation is performed after the wiping operation, in consideration of being performed in a state where the gas-liquid interface in the nozzle 19 is not stable. As a result, for example, the size of the liquid droplet ejected by the pre-wiping flushing may be smaller than that of the normal flushing. For example, the ejection speed of the liquid droplets ejected by the pre-wiping flushing may be higher than that of the normal flushing. The liquid discharged by the pre-wiping flushing may be received by the first liquid receiving portion 131 or the second liquid receiving portion 132 when the liquid is discharged before the acceleration operation. The liquid may be received by the pull-out portion 162 when the liquid is discharged after the stop operation.

The pressing mechanism 48 may press the diaphragm 56 by adjusting the pressure of the air chamber 72 without providing the expansion and contraction portion 67. Specifically, the pressing mechanism 48 performs displacement of the diaphragm 56 in the direction in which the volume of the liquid outflow portion 51 becomes smaller by increasing the pressure of the air chamber 72, and performs displacement of the diaphragm 56 in the direction in which the volume of the liquid outflow portion 51 increases by decreasing the pressure in the air chamber 72. When such a configuration is adopted, the pressure in the liquid ejecting portion 12 may be reduced by setting the pressure of the air chamber 72 to negative pressure smaller than the atmospheric pressure, as a pressure reducing operation.

The control portion 180 may cause the first suction mechanism 134 and the second suction mechanism 135 to perform suction cleaning as the discharge operation. In this case, the suction cap 164 functions as the liquid receiving portion that receives the liquid discharged from the nozzle 19. In the suction cleaning, the pressure in the space formed between the suction cap 164 and the liquid ejecting portion 12 is reduced, the liquid is discharged from the nozzle 19, and the discharged liquid is received by the suction cap 164. Therefore, the liquid may adhere to the nozzle surface 18 located in the space surrounded by the suction cap 164 during suction cleaning. The control portion 180 performs suction cleaning with the liquid ejecting portion 12 stopped at the position vertically above the first suction mechanism 134 and the second suction mechanism 135, and then moves the liquid ejecting portion 12 in an opposite direction of the scanning direction Xs and performs the acceleration operation. Then, the control portion 180 may perform the stop operation to stop the liquid ejecting portion 12 in the wiping region WA and perform the wiping operation.

The wiping mechanism 133 does not have the pull-out portion 162. The wiping mechanism 133 may include the base portion 143 having a plurality of through-holes 149 formed therein. The through-hole 149 may be provided in the base portion 143 at a position which is vertically below the moving regions of the first liquid ejecting portion 12A and the second liquid ejecting portion 12B. The liquid dropped from the nozzle surface 18 of the first liquid ejecting portion 12A may pass through the through-hole 149 and be received by the waste liquid pan 138.

The wiping mechanism 133 may have a plurality of pull-out portions 162. The pull-out portion 162 may be located vertically below the respective moving regions of the first liquid ejecting portion 12A and the second liquid ejecting portion 12B. The liquid dropped from the nozzle surface 18 of the second liquid ejecting portion 12B may also be received by the pull-out portion 162. In this case, the base portion 143 may not have the through-hole 149, and the maintenance unit 130 may not have the waste liquid pan 138.

The liquid ejecting apparatus 11 may be configured to include either one of the first liquid ejecting portion 12A and the second liquid ejecting portion 12B.

The control portion 180 may accelerate the liquid ejecting portion 12 in a direction different from the scanning direction Xs by the acceleration operation. For example, the control portion 180 may accelerate the liquid ejecting portion 12 in the vertical direction Z, or may accelerate the liquid ejecting portion 12 in a direction opposite to the vertical direction Z.

The liquid ejecting apparatus 11 may be a liquid ejecting apparatus that ejects or discharges a liquid other than an ink. The state of the liquid ejected from the liquid ejecting apparatus in the form of a minute amount of liquid droplets includes granular, tear-like, and thread-like droplets. The liquid here may be any material that may be ejected from the liquid ejecting apparatus. For example, the liquid may be in a state when the substance is in a liquid phase. It is assumed that the liquid includes a liquid material having high or low viscosity and a fluid material such as sol, gel water, other inorganic solvents, an organic solvent, a solution, liquid resin, liquid metal, and metal melt. The liquid includes not only a liquid as one state of a substance but also a liquid in which particles of a functional material made of a solid material such as a pigment or metal particles are dissolved, dispersed or mixed in a solvent. Typical examples of the liquid include the ink described in the above embodiment and liquid crystal. Here, it is assumed that the ink includes various liquid compositions such as a general water-based ink and an oil-based ink, a gel ink, and a hot melt ink. Specific examples of the liquid ejecting apparatus include, for example, an apparatus that ejects a liquid containing a material such as an electrode material or a color material used in manufacturing of a liquid crystal display, an electroluminescence display, a surface emitting display, a color filter, and the like in a dispersed or dissolved state. The liquid ejecting apparatus may be an apparatus that ejects a bioorganic substance used in biochip manufacturing, an apparatus that ejects a liquid as a sample used by a precision pipette, a textile printing apparatus, a micro dispenser, or the like. The liquid ejecting apparatus may be an apparatus that ejects lubricating oil into a precision machine such as a clock or a camera at a pinpoint and may be an apparatus that ejects a transparent resin liquid such as ultraviolet curable resin for forming a micro hemispherical lens used for an optical communication element, an optical lens, and the like, onto a substrate. The liquid ejecting apparatus may be an apparatus that ejects an etching liquid such as acid or alkali in order to etch a substrate and the like.

The technical idea and the effects obtained from the above-described embodiments and modification examples will be described below.

A. A liquid ejecting apparatus includes a liquid ejecting portion configured to eject a liquid from a nozzle disposed on a nozzle surface, a liquid receiving portion that receives the liquid discharged from the nozzle, a wiping mechanism that includes a wiping portion configured to wipe the nozzle surface, a liquid-ejecting-portion moving mechanism configured to move the liquid ejecting portion, and a control portion that performs an acceleration operation of moving the liquid ejecting portion after a discharge operation of discharging the liquid from the nozzle to the liquid receiving portion and before a wiping operation of wiping the nozzle surface by the wiping portion.

According to this configuration, the control portion performs the acceleration operation of moving the liquid ejecting portion after the discharge operation and before the wiping operation. Therefore, the liquid adhering to the nozzle surface by the discharge operation easily drops due to the inertial force generated by the acceleration operation. Thus, it is possible to reduce the liquid adhering to the liquid ejecting portion by dropping the liquid with the acceleration operation, and to wipe the nozzle surface well in the wiping operation performed after the acceleration operation.

B. In the liquid ejecting apparatus, the control portion may stop the liquid ejecting portion at a position at which the wiping portion and the nozzle surface are not in contact with each other, after the acceleration operation.

According to this configuration, the control portion stops the liquid ejecting portion after the acceleration operation. That is, the control portion can cause the liquid adhering to the liquid ejecting portion to be easier to drip by decelerating and stopping the liquid ejecting portion after the acceleration operation. The position where the liquid ejecting portion is stopped is a position where the nozzle surface is not in contact with the wiping portion. Therefore, the control portion can perform the wiping operation on the liquid ejecting portion in which the adhering liquid is reduced by acceleration and deceleration.

C. In the liquid ejecting apparatus, the wiping mechanism may include a band-like member that has a width equal to or larger than a width of the nozzle surface, a pressing portion that brings the band-like member into contact with the nozzle surface in order to wipe the nozzle surface, and a pull-out portion that is formed by pulling out the band-like member to face the nozzle surface in a non-contact manner. The wiping mechanism may be configured to wipe the nozzle surface of the liquid ejecting portion located in a wiping region. The control portion may move the liquid ejecting portion in a stopped state to the wiping region in the acceleration operation, and stop the liquid ejecting portion at a position at which the nozzle surface faces the pull-out portion.

According to this configuration, the control portion stops the first liquid ejecting portion at the position where the nozzle surface and the pull-out portion face each other. Therefore, it is possible to easily collect the liquid dropped when the liquid ejecting portion is stopped, in the pull-out portion.

D. The liquid ejecting apparatus may further include a waste liquid pan provided vertically below a moving region in which the liquid ejecting portion moves by the acceleration operation, and configured to receive the liquid dropped from the liquid ejecting portion.

According to this configuration, the waste liquid pan is provided vertically below the moving region of the liquid ejecting portion. Thus, even when the liquid is dropped in the middle of the liquid ejecting portion moving, it is possible to collect the liquid by the waste liquid pan.

E. In the liquid ejecting apparatus, the wiping mechanism may include a holding portion that holds the wiping portion, and a base portion that holds the holding portion to be movable in a wiping direction. A through-hole may be provided in the base portion at a position that is vertically above the waste liquid pan and is vertically below the moving region.

According to this configuration, the through-hole is provided vertically below the moving region of the second liquid ejecting portion, and the waste liquid pan is provided vertically below the through-hole. Thus, even when the wiping mechanism is provided between the moving region and the waste liquid pan, it is possible to collect the liquid dropped from the second liquid ejecting portion in the waste liquid pan by causing the liquid to pass through the through-hole.

F. A maintenance method of a liquid ejecting apparatus including a liquid ejecting portion configured to eject a liquid from a nozzle disposed on a nozzle surface, a liquid receiving portion that receives the liquid discharged from the nozzle, and a wiping mechanism that includes a wiping portion configured to wipe the nozzle surface. The method includes performing an acceleration operation of moving the liquid ejecting portion after a discharge operation of discharging the liquid from the nozzle to the liquid receiving portion and before a wiping operation of wiping the nozzle surface by the wiping portion. According to this method, it is possible to exhibit the effects similar to those of the liquid ejecting apparatus.

G. The maintenance method of a liquid ejecting apparatus may include stopping the liquid ejecting portion at a position at which the wiping portion and the nozzle surface are not in contact with each other, after the acceleration operation. According to this method, it is possible to exhibit the effects similar to those of the liquid ejecting apparatus.

What is claimed is:

1. A liquid ejecting apparatus comprising:
a liquid ejecting portion configured to eject a liquid from a nozzle disposed on a nozzle surface;
a liquid receiving portion that receives the liquid discharged from the nozzle;
a wiping mechanism that includes a wiping portion configured to wipe the nozzle surface;
a liquid-ejecting-portion moving mechanism configured to move the liquid ejecting portion; and
a control portion that performs an acceleration operation of moving the liquid ejecting portion after a discharge operation of discharging the liquid from the nozzle to the liquid receiving portion and before a wiping operation of wiping the nozzle surface by the wiping portion.

2. The liquid ejecting apparatus according to claim 1, wherein
the control portion stops the liquid ejecting portion at a position at which the wiping portion and the nozzle surface are not in contact with each other, after the acceleration operation.

3. The liquid ejecting apparatus according to claim 1, wherein
the wiping mechanism includes
a band-like member that has a width equal to or larger than a width of the nozzle surface,
a pressing portion that brings the band-like member into contact with the nozzle surface in order to wipe the nozzle surface, and
a pull-out portion that is formed by pulling out the band-like member to face the nozzle surface in a non-contact manner,
the wiping mechanism is configured to wipe the nozzle surface of the liquid ejecting portion located in a wiping region, and
the control portion moves the liquid ejecting portion in a stopped state to the wiping region in the acceleration operation, and stops the liquid ejecting portion at a position at which the nozzle surface faces the pull-out portion.

4. The liquid ejecting apparatus according to claim 1, further comprising:
a waste liquid pan provided vertically below a moving region in which the liquid ejecting portion moves by the acceleration operation, and configured to receive the liquid dropped from the liquid ejecting portion.

5. The liquid ejecting apparatus according to claim 4, wherein
the wiping mechanism includes
a holding portion that holds the wiping portion, and
a base portion that holds the holding portion to be movable in a wiping direction,
and
a through-hole is provided in the base portion at a position that is vertically above the waste liquid pan and is vertically below the moving region.

6. A maintenance method of a liquid ejecting apparatus including a liquid ejecting portion configured to eject a liquid from a nozzle disposed on a nozzle surface,
a liquid receiving portion that receives the liquid discharged from the nozzle, and
a wiping mechanism that includes a wiping portion configured to wipe the nozzle surface,
the method comprising:
performing an acceleration operation of moving the liquid ejecting portion after a discharge operation of discharging the liquid from the nozzle to the liquid receiving portion and before a wiping operation of wiping the nozzle surface by the wiping portion.

7. The maintenance method of a liquid ejecting apparatus according to claim 6, further comprising:
stopping the liquid ejecting portion at a position at which the wiping portion and the nozzle surface are not in contact with each other, after the acceleration operation.

8. The liquid ejecting apparatus according to claim 1, wherein
an acceleration in the acceleration operation is larger than an acceleration when the liquid ejecting portion ejects the liquid from the nozzle onto a medium while moving.

9. The maintenance method of a liquid ejecting apparatus according to claim 6, wherein
an acceleration in the acceleration operation is larger than an acceleration when the liquid ejecting portion ejects the liquid from the nozzle onto a medium while moving.
